(19) United States
(12) Patent Application Publication
(10) Pub. No.: US 2013/0308235 A1
(43) Pub. Date: Nov. 21, 2013

(54) METHOD FOR ELIMINATING A FAULT ON A HIGH-VOLTAGE DC LINE, SYSTEM FOR TRANSMITTING AN ELECTRIC CURRENT VIA A HIGH-VOLTAGE DC LINE, AND CONVERTER

(71) Applicants: Mark Davies, Howrah (AU); Herbert Gambach, Uttenreuth (DE)

(72) Inventors: Mark Davies, Howrah (AU); Herbert Gambach, Uttenreuth (DE)

(73) Assignee: SIEMENS AKTIENGESELLSCHAFT, Muenchen (DE)

(21) Appl. No.: 13/983,240

(22) PCT Filed: Feb. 1, 2011
(86) PCT No.: PCT/EP2011/051400

§ 371 Date: Aug. 1, 2013

(51) Int. Cl. H02H 9/02

(52) U.S. Cl. CPC H02H 9/02
USPC 361/62

(57) ABSTRACT

In order to be able to eliminate a fault on a high-voltage DC line with an AC voltage supply system which is connected via a self-commutated converter in a reliable manner with a comparatively low level of expenditure, the short-circuiting current flowing in the event of the fault is reduced by way of driving in each case at least one H-bridge submodule in phase branches of the converter, which is of modular design, so as to generate a counter-voltage to the voltage across the arc. There is also provide a system for transmitting an electric current via a high-voltage DC line, and also a converter.

The invention relates to a method for eliminating a fault on a high-voltage direct-current line to which an AC power supply system is connected via a self-commutated converter.

A method of this type is known from the translation DE 698 37 414 T2 2007.12.20 of the European patent specification EP 0 867 998 B1. The reason is that said document reveals a method for high-voltage direct-current transmission via an electrical system having a DC power supply system having two lines and AC power supply systems connected thereto via converters. In the known method, a parallel circuit comprising at least one blocking semiconductor component and an overvoltage arrester is used in one of the lines in order to limit a current quickly in the event of a fault, for example in the event of a ground fault in the DC power supply system. In the normal operating mode, the blocking semiconductor component is kept open, whereas, in the event of a fault on the DC power supply system side, said blocking semiconductor component is alternately closed and opened at high frequency by a control device, as a result of which the current is limited and, if appropriate, the current is also interrupted.

The invention is based on the problem of providing a method for eliminating a fault on a high-voltage direct-current line, which method can be carried out reliably and with relatively little expenditure.

In order to solve this problem, in the case of the method mentioned at the outset, the invention provides that, in the event of a fault on the high-voltage direct-current line, in order to extinguish an arc on the high-voltage direct-current line,

the short-circuit current which flows in the event of the fault is reduced by operating at least one H-bridge submodule in phase branches of the converter, which is of modular design and has a plurality of half-bridge submodules, so as to produce a countervoltage to the voltage across the arc. H-bridge submodules are known, for example, from the article “New Concept for High Voltage-Modular Multilevel Converter”, PESC 2004 Conference in Aachen, Germany.

The in each case at least one H-bridge submodule is operated directly after switches which are arranged in the AC power supply system on that side of the converter which is remote from the high-voltage direct-current line are opened because of the short circuit.

In the case of the method according to the invention, in the event of a fault, advantageously no additional circuit elements are necessary on or in the high-voltage direct-current line in order to interrupt the current. The reason is that these circuit elements lead to additional losses in fault-free operation. In the method according to the invention, however, it is only necessary to use a self-commutated converter which is of modular design and has at least one H-bridge submodule and, in the event of a fault, after the switches in the AC power supply system have been opened, to operate said converter in such a way that a countervoltage to the voltage across the arc is produced; as a result of this, the current which flows via the fault location from the inductances of the self-commutated converter of modular design and from the inductances which are active on the DC-voltage side between the DC-voltage terminals of the converter and the fault location is reduced considerably more quickly than would be the case without the configuration according to the invention. In this case, the number of H-bridge submodules is determined by the level of the countervoltage to be produced in each case. The remaining submodules of the converter can be half-bridge submodules, which has an advantageous effect on the manufacturing costs of the converter as a whole. Moreover, the losses in the converter are kept small as a result. Half-bridge submodules are also known, for example, from the article “New Concept for High Voltage-Modular Multilevel Converter”, PESC 2004 Conference in Aachen, Germany.

In the case of the method according to the invention, a converter is advantageously used in which the number of H-bridge submodules is smaller than the number of half-bridge submodules. In order to reduce manufacturing costs and losses, converters are therefore used which in each case have as few H-bridge submodules as possible and as many half-bridge submodules as possible.

In the case of the method according to the invention, the converter can be operated as a rectifier or as an inverter, depending on the direction of flow of energy.

The invention also relates to a system for transmitting an electric current via a high-voltage direct-current line to which an AC power supply system is connected via a self-commutated converter.

On the basis of a system of this type according to the prior art mentioned at the outset, another problem of the invention is to further develop said system such that it is able to eliminate faults in the DC power supply system with comparatively low expenditure given low losses.

In order to solve this problem, the invention provides that the converter is of modular design and has, in the phase branches thereof, in each case at least one H-bridge submodule in a series circuit with a plurality of half-bridge submodules.

A converter of this type means that, after switches in the AC power supply system have been opened because of a short circuit, the system according to the invention is able, when the at least one H-bridge submodule thereof is operated in such a way that a countervoltage to the voltage across the arc is produced in the event of a fault, to relatively quickly reduce the short-circuit current enough for the fault to be eliminated; in this case, during normal operation of the system and when no faults are present in the high-voltage direct-current line, losses are kept comparatively low because the system according to the invention does not require additional blocking elements and surge arresters in the DC power supply system by virtue of the converter itself or the H-bridge submodules thereof being controlled as appropriate.

In the case of the system according to the invention, in order to keep the manufacturing costs and the electrical losses low, the number of H-bridge submodules in the series circuit is smaller than the number of half-bridge submodules.

In the system according to the invention, the converter can be used both as a rectifier and as an inverter.

The invention also relates to the problem of proposing a converter which can advantageously be inserted between a high-voltage direct-current line and an AC power supply system.

In order to solve this problem, the invention provides that the converter is of modular design and has, in the phase branches thereof, in each case at least one H-bridge submodule in a series circuit with a plurality of half-bridge submodules.

The essential advantage of the converter according to the invention is that, by operating the submodules thereof after switches in the AC power supply system connected to the converter have been opened because of a short circuit, a fault on the high-voltage direct-current line can be quickly eliminated. Moreover, the use of the H-bridge submodules means that the size of the short-circuit current on the DC-voltage side is limited; additional switching elements on the overhead line are not required. In addition, a converter such as this has relatively low losses owing to the comparatively few H-bridge submodules thereof.

Advantageously, in the case of the converter according to the invention, the number of H-bridge submodules in the series circuit is smaller than the number of half-bridge submodules.

For further explanation of the invention,

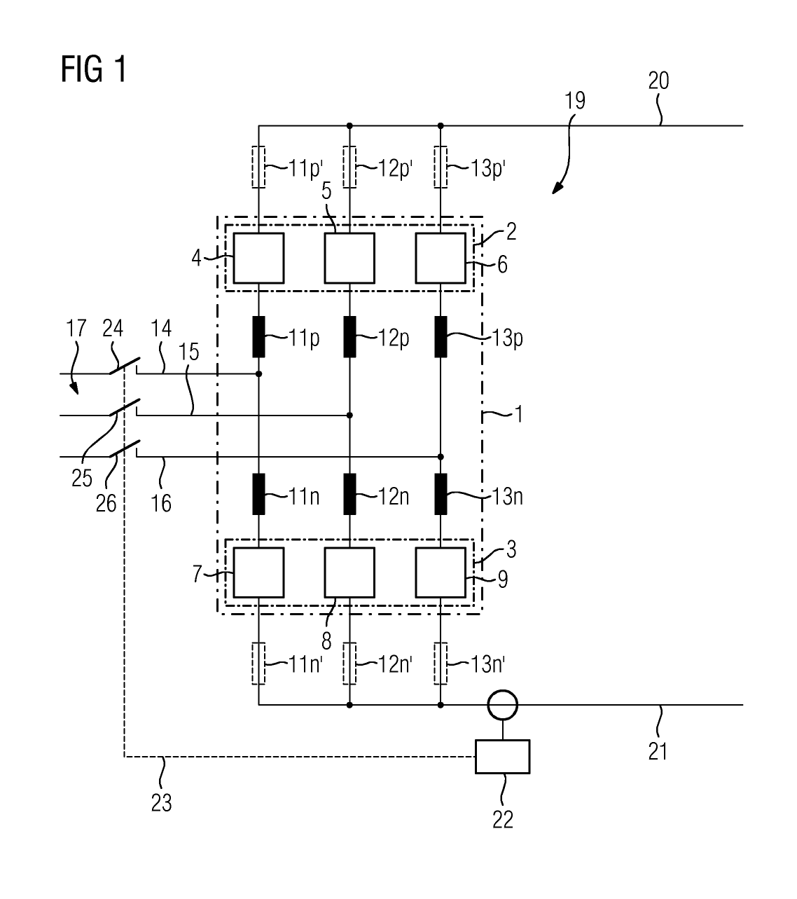

FIG. 1 shows an exemplary embodiment of a system for performing the method according to the invention having switches actuatable on the AC voltage side and

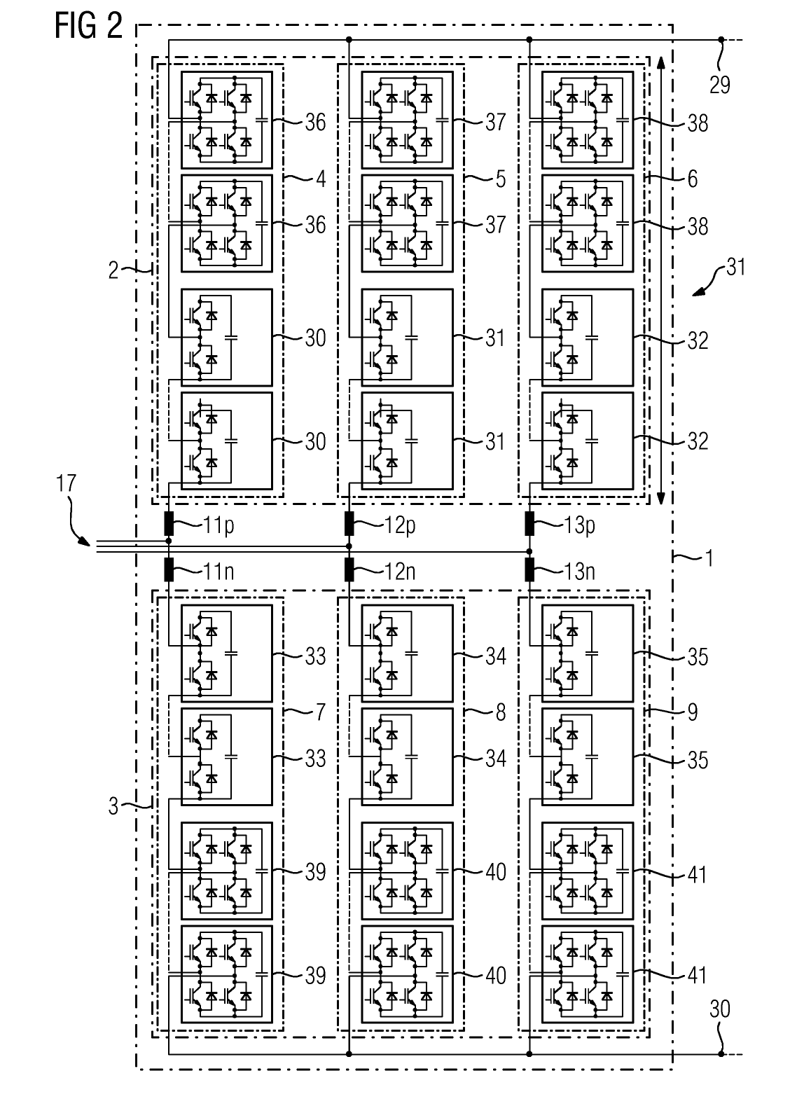

FIG. 2 shows an exemplary embodiment of the converter according to the invention.

The system shown in FIG. 1 has a self-commutated converter 1, shown only schematically, which consists in a known manner of a positive-side converter part 2, shown here only in the form of a block diagram, and a negative-side converter part 3, having phase branches 4, 5 and 6 or, respectively, 7, 8 and 9. The converter 1 is usually connected, via coils 11p, 12p and 13p or, respectively, 11n, 12n and 13n, to the three phase conductors 14, 15 and 16 of an AC power supply system 17. However, the coils can also be arranged on the DC-voltage side of the converter 1, as is indicated with dashed lines in FIG. 1 with the reference signs 11p′ to 13n′.

On that side of the converter 1 which is remote from the AC power supply system 17, a high-voltage direct-current line 19 is connected on both sides by means of the two lines 20 and 21 thereof. An arrangement 22 for detecting a short-circuit current flowing in the event of a fault on the high-voltage direct-current line 19 is connected in the line 21, which arrangement prompts switches 24, 25 and 26 in the phase conductors 14, 15 and 16 to be actuated via an electrical connection 23, shown with a dashed line, in the event of a fault. The opened switches 24 to 26 interrupt the connection between the AC power supply system 17 and the high-voltage direct-current line 19.

The self-commutated converter 1 shown in FIG. 1 is shown in detail with the positive-side converter part 2 thereof and the negative-side converter part 3 thereof in FIG. 2; each of said converter parts 2 and 3 consists of the three positive-side phase branches 4, 5 and 6 and of the three negative-side phase branches 7, 8 and 9. Each phase branch 4 to 9, for its part, consists of N submodules on each of the positive and negative sides, wherein the positive-side phase branches 4 to 6 have in each case a number k of half-bridge submodules 30, 31 and 32 and the negative-side phase branches 7 to 9 likewise have a number k of half-bridge submodules 33, 34 and 35. Each phase branch 4 to 6 and 7 to 9 contains N-k H-bridge submodules 36, 37 and 38 or, respectively, 39, 40 and 41 in series with the k half-bridge submodules 30 to 32 or, respectively, 33 to 35.

If a fault occurs on the high-voltage direct-current line 19, the accompanying short-circuit current is detected by the arrangement 22 and the switches 24 to 26 are opened, as a result of which the AC power supply system 17 is disconnected from the high-voltage direct-current line 19. However, owing to the electric power stored in the coils 11p to 13p and 11n to 13n and in the inductances that are active on the DC-voltage side (for example the inductance of a cable connected on the DC-voltage side as a direct-current line up to the fault location or an overhead line connected on the DC-voltage side up to the fault location), a short-circuit current continues to flow to the fault location on the high-voltage direct-current line 19. In order to quickly reduce said current and thus eliminate the fault on the high-voltage direct-current line 19, the H-bridge submodules 36 to 41 are operated by a control arrangement, which, for reasons of improved clarity, is not shown in the figures, in such a way that a countervoltage to the voltage across the fault location or across the arc is produced; said countervoltage quickly reduces the short-circuit current and eliminates the fault on the high-voltage direct-current line 19. In this case, the number N-k of H-bridge submodules 36 to 41 is selected to be large enough for a sufficiently high countervoltage to be able to be produced and, as a result, a rapid reduction in the short-circuit current with consequent elimination of the fault to be possible. Furthermore, with appropriate operation, the H-bridge submodules also prompt a decrease in the magnitude of the short-circuit current.

In this case, the number N-k of H-bridge submodules can beneficially be kept relatively low, which has an advantageous effect on the component costs of the self-commutated converter 1; the number k of inexpensive half-bridge submodules 30 to 35 is then relatively large.

1-10. (canceled)

11. A method of eliminating a fault on a high-voltage direct-current line connected via a self-commutated converter to AC power supply system, the method which comprises:
providing the converter in modular design with H-bridge submodules in phase branches thereof and a plurality of half-bridge submodules;
in the event of a fault on the high-voltage direct-current line, extinguishing an arc on the high-voltage direct-current line by:
reducing a short-circuit current flowing in the event of the fault by operating in each case at least one H-bridge submodule in a phase branch of the converter so as to produce a counter-voltage to a voltage across the arc.

12. The method according to claim 11, wherein a number of H-bridge submodules in the converter is smaller than a number of half-bridge submodules.

13. The method according to claim 11, which comprises operating the converter as a rectifier.

14. The method according to claim 11, which comprises operating the converter as an inverter.

15. A system for transmitting an electric current, comprising:
a high-voltage direct-current line, an AC power supply system, and a self-commutated converter connecting said AC power supply system to said high-voltage direct-current line;
said converter being a modular converter with phase branches and, connected in said phase branches, in each case at least one H-bridge submodule connected in a series circuit with a plurality of half-bridge submodules.

16. The system according to claim 15, wherein a number of said H-bridge submodules in said series circuit is smaller than a number of said half-bridge submodules.

17. The system according to claim 15, wherein said converter is driven as a rectifier.

18. The system according to claim 15, wherein said converter is driven as an inverter.

19. A converter for transmitting an electric current, the converter comprising:
a plurality of modules together forming the converter with phase branches and having, in the phase branches thereof, in each case at least one H-bridge submodule in a series circuit with a plurality of half-bridge submodules.

20. The converter according to claim 19, wherein a number of said H-bridge submodules in said series circuit is smaller than a number of said half-bridge submodules
